(19) United States
(12) Patent Application Publication
(10) Pub. No.: US 2011/0273685 A1
(43) Pub. Date: Nov. 10, 2011

(54) PRODUCTION OF AN ALIGNMENT MARK

(75) Inventors: Chung-Hsun LI, Xihu (TW); Richard Johannes Franciscus Van Haren, Waalre (NL); Sami Musa, Veldhoven (NL); David Deckers, Schilde (BE); Shun-Der Wu, Tainan (TW)

(73) Assignee: ASML NETHERLANDS B.V., Veldhoven (NL)

(21) Appl. No.: 13/075,980

(22) Filed: Mar. 30, 2011

Related U.S. Application Data
(60) Provisional application No. 61/332,016, filed on May 6, 2010.

(51) Int. Cl. G03B 27/42

(52) U.S. Cl. 355/53; 355/77

(57) ABSTRACT

A method of production of alignment marks uses a self-aligned double patterning process. An alignment mark pattern is provided with first and second sub-segmented elements. After selecting the dipolar illumination orientation, dipole-X is used to illuminate the pattern and to image the first elements on the wafer, but not the second elements. Alternatively, dipole-Y is used to illuminate the pattern and to image the second elements on the wafer, but not the first elements. In either case, self-aligned double patterning processing may then be performed to produce product-like alignment marks with high contrast and wafer quality (WQ). Subsequently the X and Y alignment marks thus produced are used for the step of alignment in a lithographic process.

### CROSS-REFERENCE TO RELATED APPLICATION

This application claims priority and benefit under 35 U.S.C. §119(e) to U.S. Provisional Patent Application No. 61/332,016, entitled “Production of an Alignment Mark,” filed on May 6, 2010. The content of that application is incorporated herein in its entirety by reference.

### FIELD

The present invention relates to a method of, and a patterning device and lithographic apparatus for, producing an alignment mark on a substrate.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

Typically, a pattern that is to be imaged on a layer of the substrate should be aligned with one or more patterns that have been imaged in a respective preceding patterning step. To this end, optical alignment methods are known that employ alignment marks on the substrate to obtain position and orientation references.

Alignment marks consist of gratings that in general have periodicity larger than the wavelength of an alignment illumination beam. During an alignment procedure the alignment illumination beam impinges on the grating, and from the diffracted light as generated by the grating an alignment sensor can obtain the information on the position and orientation of the substrate.

For proper processing the constituent parts of the alignment mark that typically consist of the same material as (parts of) device features, should generally have dimensions similar to dimensions of the device features that are manufactured by the lithographical processing to avoid size-induced deviations during processing of integrated circuits, due to, for example, a micro-loading effect during a reactive ion etching process which may occur at device structures in the vicinity of a large marker area or due to size dependency of chemical-mechanical polishing (CMP) of structures. To comply with processing conditions and state-of-the-art design rules usually sub-segmented marks are being used. Sub-segmented marks that are being used include marks that consist of perpendicular sub-alignment wavelength lines.

Current state-of-the-art photo lithography scanners using 193 nm wavelength lasers and numerical apertures of 1.35 have reached fundamental limits of 40-45 nm (half-pitch). However, device trends continue to drive for smaller feature sizes, and therefore some IC manufacturers have turned to double patterning techniques. A known double patterning technique is called ‘Self-Aligned Double Patterning (SADP)’, which technique is also known as ‘Sidewall Spacer Double Patterning (SSDP)’ or ‘Spacer Technology (SPT).’

There is a problem related to using SADP processing with standard, non-sub-segmented alignment marks. After SADP processing, the spatial frequency and the duty cycle of standard alignment marks, with micron-scale lines in the alignment pattern, are usually drastically changed. Basically this makes the standard alignment marks become undetectable, since both changes in spatial frequency and duty cycle greatly deteriorate the strength of the alignment signal. Signal strength is quantified with wafer quality (WQ), which is the percentage of the actual alignment signal strength with reference to a signal generated by a fiducial mark. Traditional non-sub-segmented alignment marks are not useful for SADP processing because the highest WQ that can be achieved with SADP processing is usually far below the threshold value for WQ to ensure good alignment performance.

There are also two problems related to using SADP processing with sub-segmented alignment marks.

The first problem is printability. In spacer technology (SPT) extreme dipolar illumination settings may be used, i.e. an illumination mode making use of two beams converging on the patterning device (reticle). Most manufacturers use these illumination settings, such as dipole-X or dipole-Y, for the critical layer in advanced nodes. It is observed that due to these extreme illumination conditions, sub-segmented alignment marks, and in particular polar marks, may not be imaged properly. This results in poorly defined alignment marks or even in a failure to create alignment marks, depending on the orientation of the dipolar illumination relative to the direction of the sub-segmentation. Use of poorly defined marks in optical alignment may lead to alignment position errors. If the poor printability results in an alignment mark with an unintentional asymmetry, such an alignment mark may cause an alignment position shift

The second problem is that polar marks when used in SPT lead to a low signal strength. This is because not enough spacer nitride pattern density remains after SPT processing. Also there is a small refractive index difference between lines and spaces, which result in less reflective signal.

US Patent Application Publication No. US2009/0310113 discloses the use of sub-segmented alignment marks with extreme dipolar illumination settings. An alignment mark on a substrate is disclosed, comprising a periodic structure of first and second sub-segmented elements being arranged in an alternating repetitive sequence on a substrate. It is disclosed that printability of these alignment marks is strongly enhanced by the use of sub-segmentation with a segmentation sub-pitch of the first and second elements respectively perpendicular to the plane of incidence containing the two illuminating beams. The problem with that approach is that different marks are required for either dipole-X or dipole-Y illumination respectively. This requires consideration of the matching of the mark to the dipolar illumination setting to be used. When the reticle is for use with two dipolar illumination settings, dipole-X and dipole-Y, providing marks for both settings uses valuable space on the reticle.

However, the marks disclosed in US2009/0310113 suffer from the problem that the polar marks when used in SPT have, which is low signal strength. This is again because not enough spacer nitride pattern density remains after SPT processing. Also, again, there is a small refractive index difference between lines and spaces, which result in less reflective signal.

### SUMMARY

It is desirable to have a method of producing an alignment mark that overcomes at least some of the problems of the prior art.

According to a first aspect of the present invention, there is provided a method of producing an alignment mark on a substrate, said method comprising the steps:

providing an alignment pattern on a patterning device, said alignment pattern comprising a plurality of first elements and a plurality of second elements; and illuminating said alignment pattern with dipolar illumination having a first orientation to form an image of said alignment pattern,

wherein said alignment pattern is such that under said dipolar illumination having said first orientation said first elements are imaged on said substrate to produce said alignment mark and said second elements are not imaged on said substrate, while, had said alignment pattern been illuminated with dipolar illumination having a second orientation, said first elements would not have been imaged on said substrate, and said second elements would have been imaged on said substrate to produce said alignment mark.

According to a second aspect of the present invention, there is provided a patterning device for producing an alignment mark on a substrate, said patterning device comprising:

an alignment pattern, said alignment pattern comprising a plurality of first elements and a plurality of second elements,

wherein each first element comprises a first periodic sub-structure having a first sub-pitch, said first periodic sub-structure comprising a plurality of first sub-lines and a plurality of first sub-spaces, said first sub-lines and first sub-spaces being arranged in an alternating repetitive sequence in a first sub-pitch direction, said first sub-lines extending along said patterning device in a direction perpendicular to said first sub-pitch direction and each second element comprising a second periodic sub-structure having a second sub-pitch, said second periodic sub-structure comprising a plurality of second sub-lines and a plurality of second sub-spaces, said second sub-lines and second sub-spaces being arranged in an alternating repetitive sequence in a second sub-pitch direction, said second sub-lines extending along said patterning device in a direction perpendicular to said second sub-pitch direction,

wherein said first sub-pitch direction is different from said second sub-pitch direction, and wherein said first periodic sub-structure is sized such that under dipolar illumination having a first orientation to form an image of said alignment pattern said first elements are imaged on said substrate to produce said alignment mark and said second periodic sub-structure is sized such that under said dipolar illumination having said first orientation said second elements are not imaged on said substrate, and said first periodic sub-structure is sized such that under dipolar illumination having a second orientation to form an image of said alignment pattern said first elements would not be imaged on said substrate and said second periodic sub-structure is sized such that under said dipolar illumination having said second orientation said second elements would be imaged on said substrate to produce said alignment mark.

According to a third aspect of the present invention, there is provided a lithographic apparatus for producing an alignment mark on a substrate, said lithographic apparatus comprising:

a patterning device comprising an alignment pattern, said alignment pattern comprising a plurality of first elements and a plurality of second elements; and

an illumination system operable to illuminate said alignment pattern with dipolar illumination having a first orientation to form an image of said alignment pattern,

wherein said alignment pattern is such that under said dipolar illumination having said first orientation said first elements are imaged on said substrate to produce said alignment mark and said second elements are not imaged on said substrate, while had said alignment pattern been illuminated with dipolar illumination having a second orientation, said first elements would not have been imaged on said substrate, and said second elements would have been imaged on said substrate to produce said alignment mark.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts an alignment mark from the prior art;

FIG. 3 depicts production of an alignment mark using a 22-nm node self-aligned double patterning process, in accordance with an embodiment of the present invention;

FIG. 4 depicts a sub-segmented alignment pattern provided in accordance with an embodiment of the present invention;

FIG. 5 is a graph of simulated contrast of vertical and horizontal lines with 90 nm-pitch and 45 nm-critical dimensions and a dipole-X illumination setting;

FIG. 6 depicts production of an X alignment mark using a dipole-X illumination setting and a self-aligned double patterning process, in accordance with an embodiment of the present invention;

FIG. 7 depicts X and Y alignment marks produced using a dipole-X illumination setting and a self-aligned double patterning process, in accordance with an embodiment of the present invention;

FIG. 8 depicts production of an X alignment mark using a dipole-Y illumination setting and a self-aligned double patterning process, in accordance with an embodiment of the present invention;

FIG. 9 depicts X and Y alignment marks produced using a dipole-Y illumination setting and a self-aligned double patterning process, in accordance with an embodiment of the present invention; and

FIG. 10 is a flow chart of production of alignment marks using a self-aligned double patterning process, in accordance with an embodiment of the present invention and its use for alignment.

### DETAILED DESCRIPTION

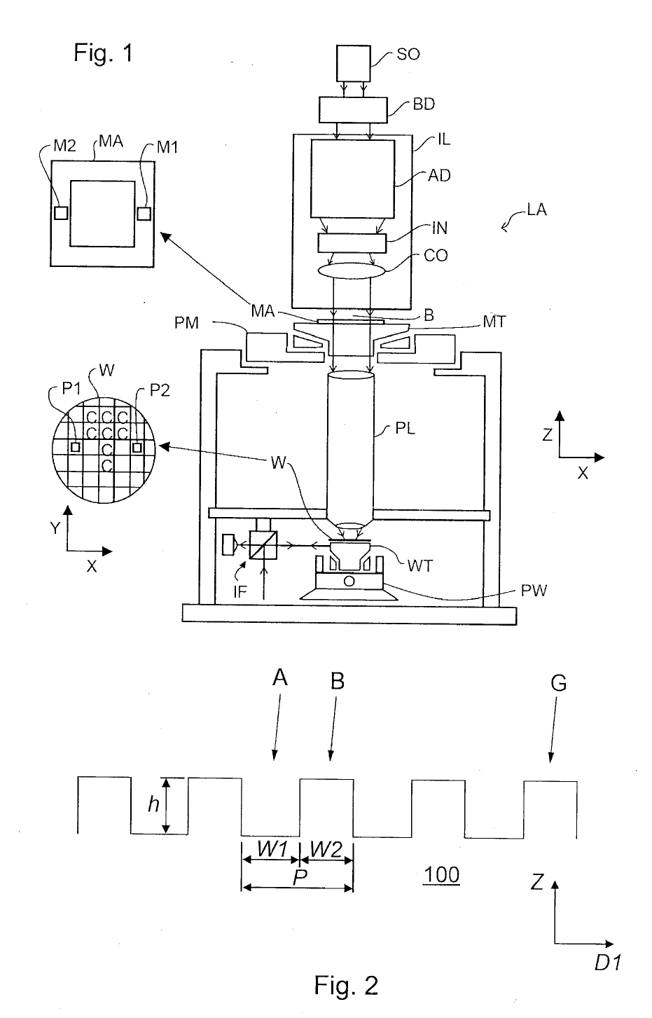

FIG. 1 schematically depicts a lithographic apparatus according to one embodiment of the invention. The apparatus comprises:

an illumination system (illuminator) IL configured to condition a radiation beam B (e.g. UV radiation or EUV radiation).

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The tem “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing minors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

FIG. 2 depicts a cross-section of an alignment mark from the prior art. On a substrate 100, a grating G is arranged which comprises a series of parallel lines B and a series of trenches A, that are arranged in an alternating repetitive sequence in the horizontal direction D1. The depth of the trenches h is taken along a vertical direction Z.

The lines B and trenches A extend, parallel to each other, along a direction D2 orthogonal to the horizontal direction D1 and the vertical direction Z.

The prior art alignment mark has a mark pitch or mark periodicity P which equals a width W1 of one trench A and a width W2 of one line B.

During an alignment procedure, a substantially monochromatic radiation beam with a wavelength λ is provided for impingement on the grating and generates a diffraction pattern. The radiation beam is generated by any suitable light source, such as a laser device. The diffraction pattern is detected by a sensor (sensor device) and from the measured pattern information on position and orientation of the grating G can be obtained. In the prior art, the pitch P is selected to be larger than the wavelength of the impinging radiation beam.

The ratio of the width W1 of the trench A and the width W2 of the line B which is also referred to as the duty cycle of the alignment mark, has an effect on signal strength, i.e., the intensity of the diffracted light as measured or received by the sensor.

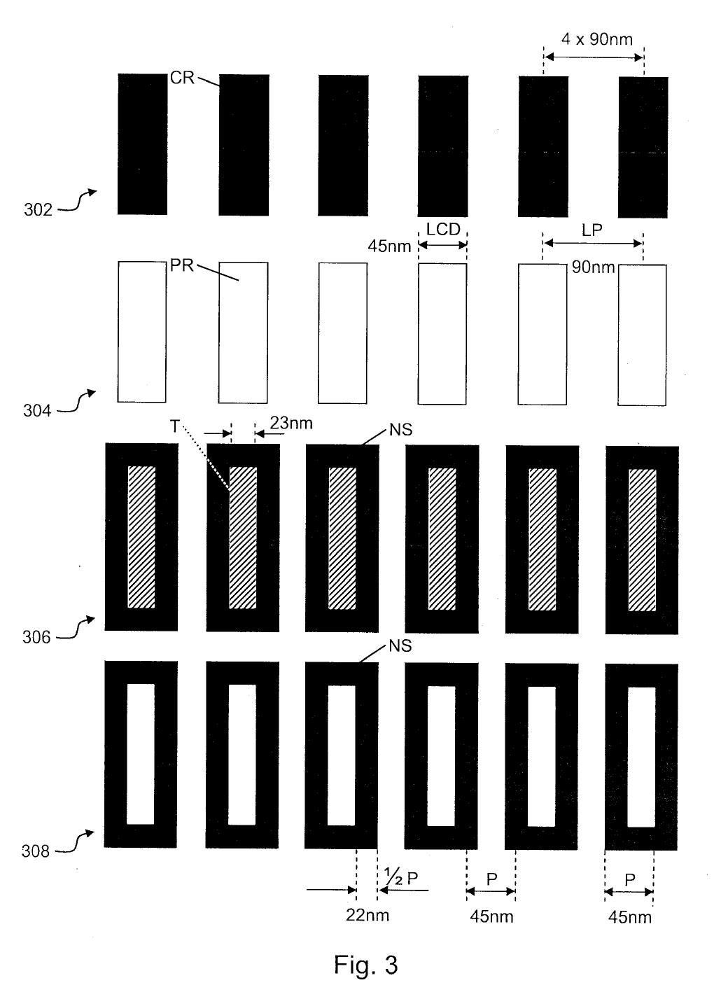

FIG. 3 depicts steps in the production of a sub-segmented element of an alignment mark using a self-aligned double patterning processin accordance with an embodiment of the present invention. For explanatory reasons a numerical example of the 22-nm lithography node is used. Chrome lines CR are arranged in a grating 302 on a reticle with pitch of 4×90 nm. After imaging on a wafer using a 4× reduction scanner, photoresist lines PR in a grating 304 are imaged on a substrate. The photoresist lines are vertical lines in the “line” element of a sub-segmented alignment mark. They have a line CD (LCD) of 45 nm and a line pitch (LP) of 90 nm. After the photoresist trimming, then spacer deposition and etch steps of SADP processing, the amorphous carbon (α-C) template lines T remain in grating 306 with a line width of 23 nm, surrounded by the nitride spacer (NS). Finally, after the template T is stripped, just the nitride spacer NS remains in grating 308. Gratings 302 to 308 are not drawn to vertical scale. In practice the lines would be stretched vertically, giving a much larger aspect ratio. The horizontal pitch P of the final nitride spacer lines NS is 45 nm and the half-pitch ½P is 22 nm. This gives a line-to-space duty cycle of 50%, which results in an improved wafer quality (WQ).

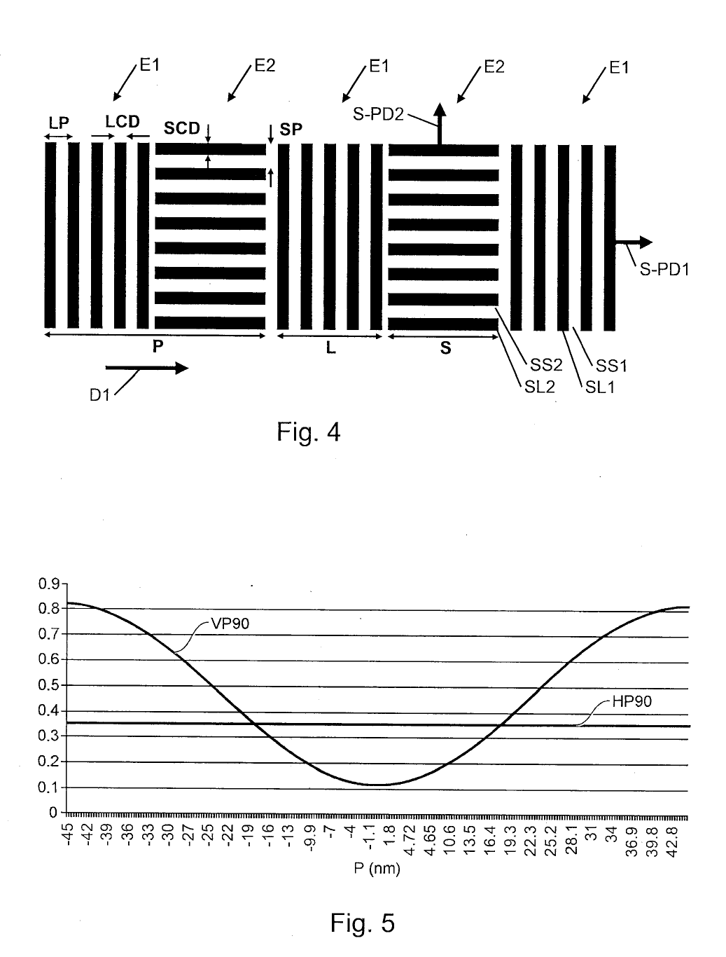

FIG. 4 depicts a sub-segmented alignment pattern provided in accordance with an embodiment of the present invention. The alignment pattern is provided on a patterning device, such as a scanner or stepper reticle. It comprises a plurality of first elements E1 and a plurality of second elements E2, corresponding to the sub-segmented lines L and spaces S on the alignment mark.

The first elements E1 and second elements E2 comprise a periodic structure with the first and second elements being arranged in an alternating repetitive sequence in a first direction D1. Each first element E1 comprises a first periodic sub-structure having a first sub-pitch LP, and comprises first sub-lines SL1 and first sub-spaces SS1 arranged in an alternating repetitive sequence in a first sub-pitch direction S-PD1. The first sub-lines SL1 extend along the surface of the reticle in a direction perpendicular to the first sub-pitch direction S-PD1. Each second element E2 comprises a second periodic sub-structure having a second sub-pitch SP, and comprises second sub-lines SL2 and second sub-spaces SS2 arranged in an alternating repetitive sequence in a second sub-pitch direction S-PD2. The second sub-lines SL2 extend along the surface of the reticle in a direction perpendicular to the second sub-pitch direction S-PD2. The first sub-pitch direction S-PD1 is different from the second sub-pitch direction S-PD2. In this embodiment, the first sub-pitch direction S-PD1 is perpendicular to the second sub-pitch direction S-PD2 and the first sub-pitch direction S-PD1 is parallel to the first direction Dl.

In one embodiment of the present invention, the sub-segmented alignment marks are sized to have the same feature sizes as memory device features (product), which have a pitch of 130 nm and CD of 65 nm for 32 nm-half-pitch. For 22 nm-half-pitch, the sub-segmented alignment marks have pitch of 90 nm/CD of 45 nm. Therefore, after SADP processing, the most amount of spacers are produced. A further result is that the alignment marks are process-optimized because the feature size of the alignment marks is the same as the feature size of the product.

The alignment pattern is provided in accordance with an embodiment of the present invention to result in empty lines or spaces after exposure in order to have large refractive index delta between lines and spaces, which is important to boost WQ.

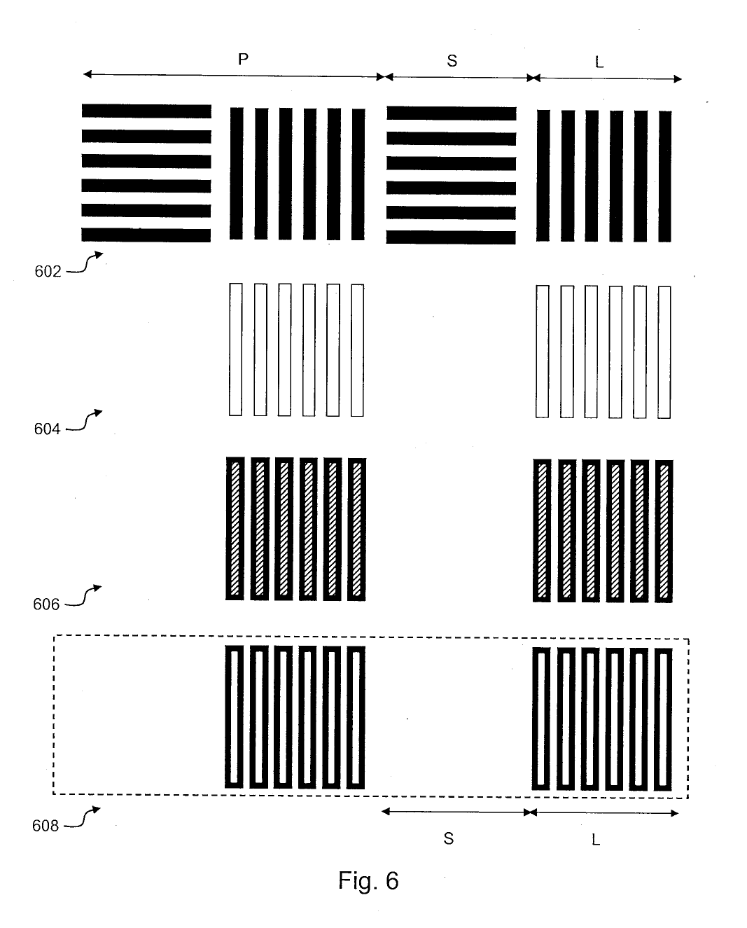

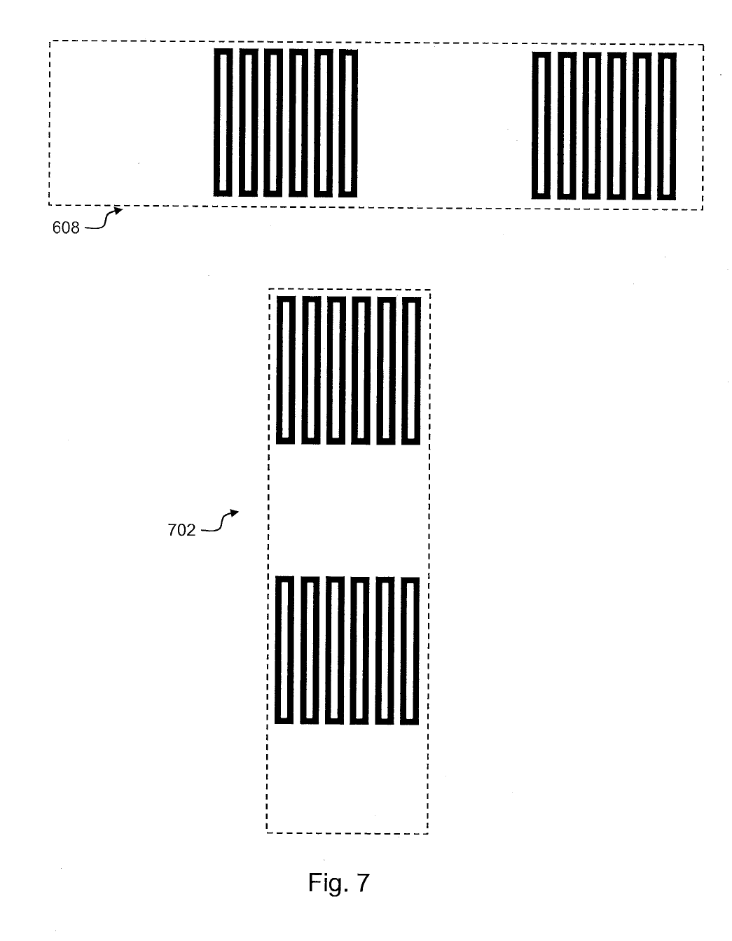

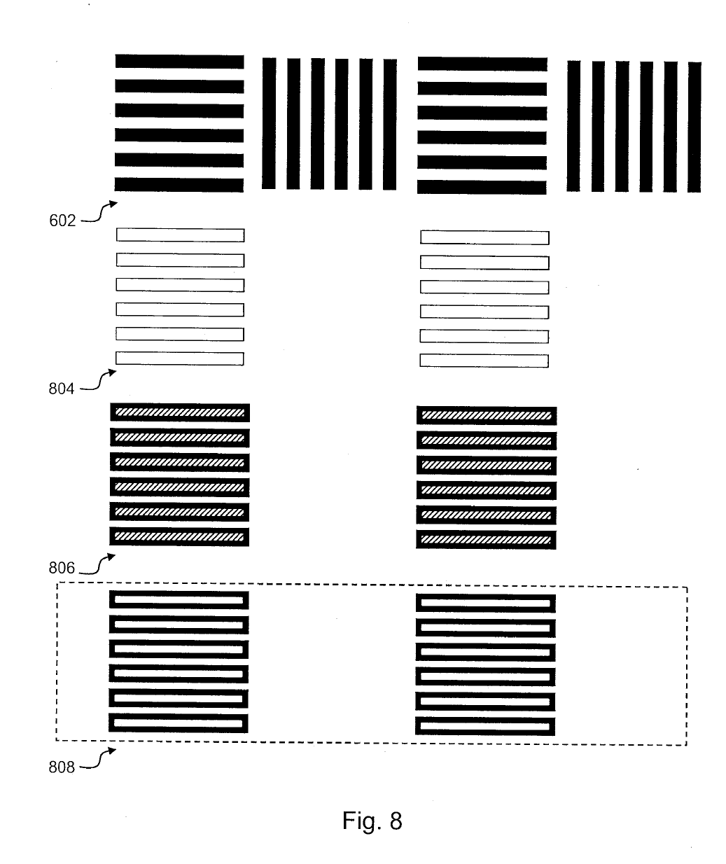

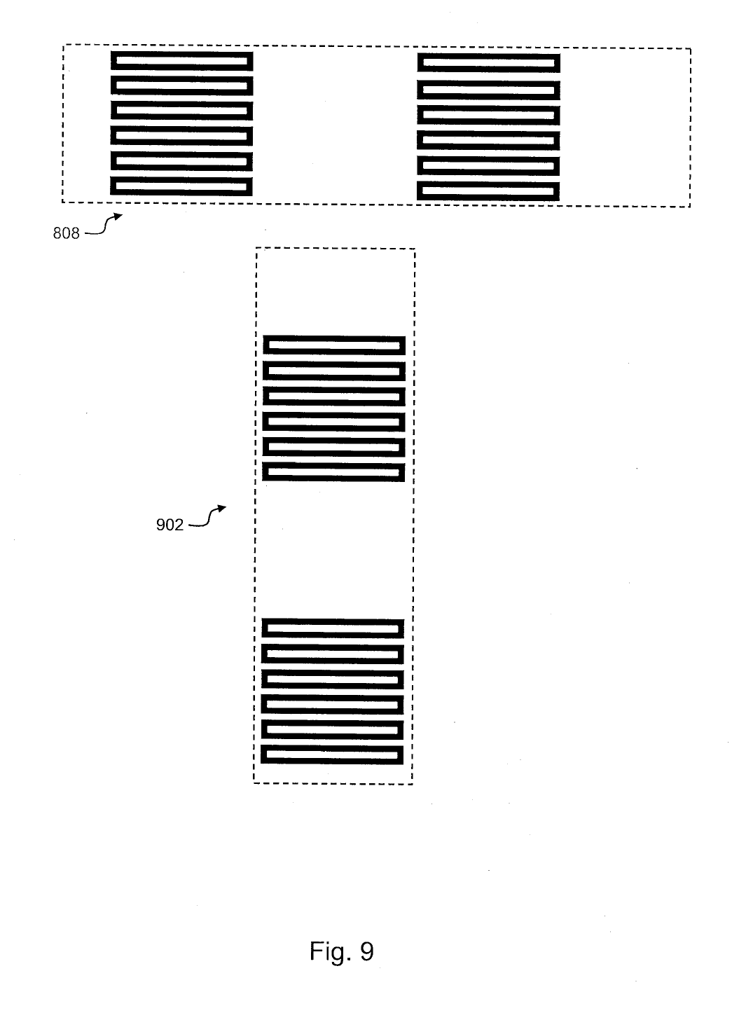

FIG. 5 depicts a graph of simulated contrast C of vertical and horizontal lines of an alignment mark with 90 nm pitch and 45 nm critical dimensions and a dipole-X illumination setting. The simulated data for the vertical lines is labeled VP90 (Vertical, Pitch 90 nm). The simulated data for the horizontal lines is labeled HP90 (Horizontal, Pitch 90 nm). As can be seen by the flat line HP90, there is no contrast for horizontal lines, which means that the horizontal lines are not imaged at all. The simulated data for vertical lines, labeled VP90, show a range of contrast, predicting that the vertical lines will be imaged with this illumination. The resulting printed alignment mark is only composed of vertical lines with empty spaces in between, because the vertical lines of the pattern are printed, but not horizontal lines. Therefore, the mark pattern is printed as a ‘product-like vertical mark’, shown as 608 and 702 in FIGS. 6 and 7. Alternatively, if dipole-Y is used, the mark will be printed as a ‘product-like horizontal mark’ shown as 808 and 902 in FIGS. 8 and 9. These marks can also be made compatible with bitlines or wordlines respectively.

FIG. 6 depicts production of an X alignment mark using a dipole-X illumination setting and a self-aligned double patterning process, in accordance with an embodiment of the present invention.

The alignment pattern 602, which was also depicted in FIG. 4, is illuminated with dipolar illumination having a first orientation, dipole-X, to form an image of said alignment pattern and the alignment pattern is designed such that the first elements (depicted as E1 in FIG. 4) arc imaged on the substrate to produce an alignment mark 604, and the second elements (depicted as E2 in FIG. 4) are not imaged on the substrate (according to the simulation data as depicted in FIG. 5). Had the alignment pattern 602 been illuminated with dipolar illumination having a second orientation, dipole-Y then the first elements would not have been imaged on the substrate, and the second elements would have been imaged on the substrate to produce the alignment mark 804 in FIG. 8. In this embodiment, the first orientation, dipole-X, is perpendicular to the second orientation, dipole-Y.

The imaged alignment mark 604 of FIG. 6 may be used with the self-aligned double patterning process described in relation to FIG. 3. The photoresist grating 604, template and nitride spacer structure 606 and final alignment mark 608 correspond to structures 304, 306 and 308 respectively in FIG. 3.

In the alignment pattern 602, the first periodic sub-structure in the “line” L is sized such that upon the step of dipole-X illumination the first elements are imaged on the substrate to produce the alignment mark 604 and the second periodic sub-structure in the “space” S is sized such that upon the step of illumination the second elements are not imaged on the substrate.

Furthermore, the first periodic sub-structure in the “line” L is sized such that had the alignment pattern been illuminated with dipole-Y illumination the first elements would not have been imaged on the substrate and the second periodic sub-structure in the “space” S is sized such that the second elements would have been imaged on the substrate to produce the alignment mark 804 in FIG. 8.

In using self-aligned double patterning to produce the alignment mark, the first sub-pitch LP in FIG. 4 is selected to result in a duty cycle of spacers NS in the first periodic sub-structure, being the ratio of the width of spacers NS of the first sub-lines (½P) and the width of gaps between spacers NS of the first sub-lines (P-½P), of 50%. The second sub-pitch SP is selected such that had the alignment pattern been illuminated with dipolar illumination having the second orientation then it would result in a duty cycle of spacers of the second periodic sub-structure, being the ratio of the width of spacers of the second sub-lines and the width of gaps between spacers of the second sub-lines, of 50%.

Thus, after the self-aligned double patterning lithography, the alignment marks are illustrated in 608, because both lines and spaces of marks can not be resolved with a given orientation of the dipolar illumination. As shown in FIG. 6, the use of dipole-X results in a “product-like vertical mark” 608.

FIG. 7 depicts both X 608 and Y 702 alignment marks produced using a dipole-X illumination setting and a self-aligned double patterning process, in accordance with an embodiment of the present invention.

With reference to FIG. 8, the imaged alignment mark 804 may be used with self-aligned double patterning process described in relation to FIG. 3. The photoresist grating 804, template and nitride spacer structure 806 and final alignment mark 808 correspond to structures 304, 306 and 308 respectively in FIG. 3. Thus, the use of dipole-Y leads to a “product like horizontal mark” 808.

FIG. 9 depicts both X 808 and Y 902 alignment marks produced using a dipole-Y illumination setting and a self-aligned double patterning process, in accordance with an embodiment of the present invention.

Therefore, the alignment pattern provided in accordance with the present invention can be printed well for both dipole-X and dipole-Y extreme illumination settings without printability problems, for both X and Y alignment marks.

By taking a product like vertical “X” mark 608 in 32 nm-node SADP as an example, the “spaces” S of the alignment mark are empty, but “lines” L contain dense straight nitride spacers. The difference between lines and spaces are designed on purpose to increase the refractive index delta. While the alignment signal wave propagates along the mark, the reflectivity is increased by this delta, which means the strength of the alignment signal can be enhanced. Moreover, LP=130 nm and LCD=65 nm, which are almost the finest printable lines for 32 nm-node. After SADP processing, the mark keeps much higher pattern density of nitride spacers than standard marks, which can also increase the signal strength (or wafer quality, WQ). Compared with WQ of standard marks (less than 0.001% at R5 and G5), alignment marks produced in accordance with embodiments of the present invention show much better alignment signal strength.

Smaller features within alignment marks may be produced in accordance with embodiments of the present invention, so as to prevent processing issues like erosion, dishing and contamination. Further, there is no need to add extra layers to protect the alignment marks from processing damage (to keep the shape of alignment mark), which can save both cost and time of the fabrication process for manufacturers. Furthermore, additional topography may be produced to further increase the intensity of the alignment signal. For instance after coating the PR/BARC (photoresist, Bottom Anti-Reflective Coating), a rough topography on top of the alignment marks may be created, which can enhance the alignment signal strength further.

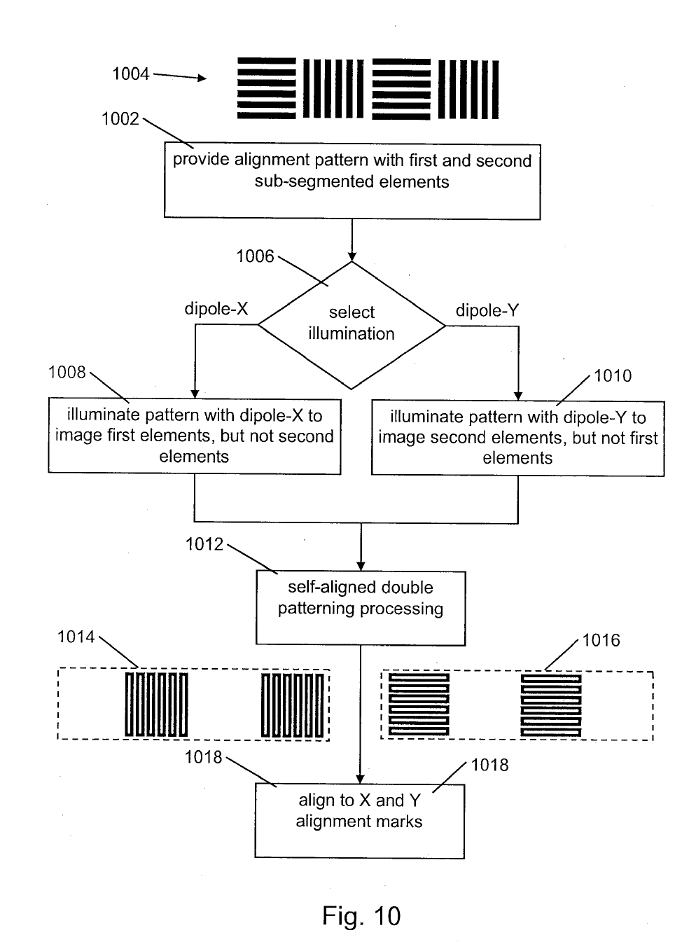

FIG. 10 is a flow chart of the production of alignment marks using a self-aligned double patterning (SADP) process, in accordance with an embodiment of the present invention, and its use for alignment. Step 1002 is to provide an alignment mark pattern 1004 with first and second sub-segmented elements, as shown in FIG. 4. After selecting at step 1006 the dipolar illumination orientation, dipole-X illumination is used in step 1008 to illuminate the pattern 1004 and to image the first elements on the wafer, but not the second elements, as shown in FIGS. 6 and 7. Alternatively, after selecting at step 1006 the dipole illumination orientation, dipole-Y illumination is used in step 1010 to illuminate the pattern 1004 and to image the second elements on the wafer, but not the first elements, as shown in FIGS. 8 and 9. In either case, self-aligned double patterning processing may then be performed at step 1012 to produce product-like alignment marks, 1014, 1016 with high contrast and wafer quality (WQ). Subsequently the X and Y product-like alignment marks 1014 and 1016 thus produced are used for the step of alignment 1018 in a lithographic process.

The method may be implemented with a patterning device and in a lithographic apparatus as described with reference to FIG. 1.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A method of producing an alignment mark on a substrate, comprising:
providing an alignment pattern on a patterning device, said alignment pattern comprising a plurality of first elements and a plurality of second elements; and
illuminating said alignment pattern with dipolar illumination having a first orientation to form an image of said alignment pattern,
wherein said alignment pattern is such that under said dipolar illumination having said first orientation said first elements are imaged on said substrate to produce said alignment mark and said second elements are not imaged on said substrate, while, had said alignment pattern been illuminated with dipolar illumination having a second orientation, said first elements would not have been imaged on said substrate, and said second elements would have been imaged on said substrate to produce said alignment mark.

2. A method according to claim 1, wherein said first orientation is perpendicular to said second orientation.

3. A method according to claim 1, wherein said first elements and said second elements comprise a periodic structure with said first elements and said second elements being arranged in an alternating repetitive sequence in a first direction.

4. A method according to claim 1 wherein each first element comprises a first periodic sub-structure having a first sub-pitch, said first periodic sub-structure comprising a plurality of first sub-lines and a plurality of first sub-spaces, said first sub-lines and first sub-spaces being arranged in an alternating repetitive sequence in a first sub-pitch direction, said first sub-lines extending along said patterning device in a direction perpendicular to said first sub-pitch direction and each second element comprising a second periodic sub-structure having a second sub-pitch, said second periodic sub-structure comprising a plurality of second sub-lines and a plurality of second sub-spaces, said second sub-lines and second sub-spaces being arranged in an alternating repetitive sequence in a second sub-pitch direction, said second sub-lines extending along said patterning device in a direction perpendicular to said second sub-pitch direction,
wherein said first sub-pitch direction is different from said second sub-pitch direction.

5. A method according to claim 4, wherein said first sub-pitch direction is perpendicular to said second sub-pitch direction.

6. A method according to claim 4, wherein said first sub-pitch direction is parallel to said first direction.

7. A method according to claim 4, wherein said first periodic sub-structure is sized such that under said dipolar illumination having said first orientation said first elements are imaged on said substrate to produce said alignment mark and said second periodic sub-structure is sized such that under said dipolar illumination having said first orientation said second elements are not imaged on said substrate.

8. A method according to claim 7, wherein said first periodic sub-structure is sized such that had said alignment pattern been illuminated with dipolar illumination having said second orientation, said first elements would not have been imaged on said substrate and said second periodic sub-structure is sized such that under said dipolar illumination having said second orientation said second elements would have been imaged on said substrate to produce said alignment mark.

9. A method according claim 8, further comprising using spacer double patterning to produce said alignment mark, wherein said first sub-pitch is selected to result in a duty cycle of spacers of said first periodic sub-structure, being the ratio of the width of spacers of said first sub-lines and the width of gaps between spacers of said first sub-lines, of 50%, and said second sub-pitch is selected such that had said alignment pattern been illuminated with dipolar illumination having said second orientation it would result in a duty cycle of spacers of said second periodic sub-structure, being the ratio of the width of spacers of said second sub-lines and the width of gaps between spacers of said second sub-lines, of 50%.

10. A patterning device for producing an alignment mark on a substrate, said patterning device comprising:
an alignment pattern, said alignment pattern comprising a plurality of first elements and a plurality of second elements,
wherein each first element comprises a first periodic sub-structure having a first sub-pitch, said first periodic sub-structure comprising a plurality of first sub-lines and a plurality of first sub-spaces, said first sub-lines and first sub-spaces being arranged in an alternating repetitive sequence in a first sub-pitch direction, said first sub-lines extending along said patterning device in a direction perpendicular to said first sub-pitch direction and each second element comprising a second periodic sub-structure having a second sub-pitch, said second periodic sub-structure comprising a plurality of second sub-lines and a plurality of second sub-spaces, said second sub-lines and second sub-spaces being arranged in an alternating repetitive sequence in a second sub-pitch direction, said second sub-lines extending along said patterning device in a direction perpendicular to said second sub-pitch direction,
wherein said first sub-pitch direction is different from said second sub-pitch direction, and wherein said first periodic sub-structure is sized such that under dipolar illumination having a first orientation to form an image of said alignment pattern said first elements are imaged on said substrate to produce said alignment mark and said second periodic sub-structure is sized such that under said dipolar illumination having said first orientation said second elements are not imaged on said substrate, and said first periodic sub-structure is sized such that under dipolar illumination having a second orientation to form an image of said alignment pattern said first elements would not be imaged on said substrate and said second periodic sub-structure is sized such that under said dipolar illumination having said second orientation said second elements would be imaged on said substrate to produce said alignment mark.

11. A patterning device according claim 10, wherein, said first sub-pitch is selected to result, upon using spacer double patterning to produce said alignment mark, in a duty cycle of spacers of said first periodic sub-structure, being the ratio of the width of spacers of said first sub-lines and the width of gaps between spacers of said first sub-lines, of 50%, and said second sub-pitch is selected such that had said alignment pattern been illuminated with dipolar illumination having said second orientation it would result, upon using spacer double patterning to produce said alignment mark, in a duty cycle of spacers of said second periodic sub-structure, being the ratio of the width of spacers of said second sub-lines and the width of gaps between spacers of said second sub-lines, of 50%.

12. A patterning device according to claim 10, wherein said first sub-pitch direction is perpendicular to said second sub-pitch direction.

13. A patterning device according to claim 10, wherein said first sub-pitch direction is parallel to said first direction.

14. A lithographic apparatus for producing an alignment mark on a substrate, said lithographic apparatus comprising:
a patterning device comprising an alignment pattern, said alignment pattern comprising a plurality of first elements and a plurality of second elements; and
an illumination system operable to illuminate said alignment pattern with dipolar illumination having a first orientation to form an image of said alignment pattern,
wherein said alignment pattern is such that under said dipolar illumination having said first orientation said first elements are imaged on said substrate to produce said alignment mark and said second elements are not imaged on said substrate, while had said alignment pattern been illuminated with dipolar illumination having a second orientation, said first elements would not have been imaged on said substrate, and said second elements would have been imaged on said substrate to produce said alignment mark.
